(19) United States
(12) Patent Application Publication
(10) Pub. No.: US 2013/0077999 A1
(43) Pub. Date: Mar. 28, 2013

(54) ELECTROGRAPHIC PRINTER USING FLUIDIC CHARGE DISSIPATION

(71) Applicants: Thomas Nathaniel Tombs, Rochester, NY (US); Donald Saul Rimai, Webster, NY (US)

(72) Inventors: Thomas Nathaniel Tombs, Rochester, NY (US); Donald Saul Rimai, Webster, NY (US)

(21) Appl. No.: 13/245,977

(22) Filed: Sep. 27, 2011

(51) Int. Cl. G03G 15/22

(52) U.S. Cl. 399/130

(57) ABSTRACT

Electrographic printing apparatus for producing a toner image on paper includes a dryer adapted to dry a selected region of the paper to a moisture content not to exceed that of the paper equilibrated to 20% RH. A liquid-deposition unit wets selected portions of the selected region of the paper within 15 seconds after the completion of drying to provide a latent fluid image corresponding to the wetted portions of the paper. A dry area is thereby defined in the selected region outside the latent fluid image. A charging member charges the paper so that the paper in the dry area has a selected potential. A development station deposits charged dry toner in the selected region, the toner having charge of the same sign as the selected potential, so that the toner adheres to paper in the area of the latent fluid image.

### CROSS-REFERENCE TO RELATED APPLICATIONS

Reference is made to commonly assigned, co-pending U.S. Patent Application Serial Numbers (K000234), filed herewith, entitled “INKJET PRINTING USING LARGE PARTICLES,” by Thomas N. Tombs, et al.; (K000298), filed herewith, entitled “INKJET PRINTER USING LARGE PARTICLES,” by Thomas N. Tombs, et al.; (K000262), filed herewith, entitled “ELECTROGRAPHIC PRINTING USING FLUIDIC CHARGE DISSIPATION,” by Thomas N. Tombs, et al.; (K000281), filed herewith, entitled “LARGE-PARTICLE INKJET PRINTING ON SEMIPOROUS PAPER,” by Thomas N. Tombs, et al.; (K000559), filed herewith, entitled “LARGE-PARTICLE SEMIPOROUS-PAPER INKJET PRINTER,” by Thomas N. Tombs, et al.; and U.S. patent application Ser. No. 13/077,496, filed Mar. 31, 2011, entitled “DUAL TONER PRINTING WITH DISCHARGE AREA DEVELOPMENT,” by William Y. Fowlkes, et al.; the disclosures of which are incorporated by reference herein.

### FIELD OF THE INVENTION

This invention pertains to the field of digitally controlled printing systems.

### BACKGROUND OF THE INVENTION

Printers are useful for producing printed images of a wide range of types. Printers print on receivers (or “imaging substrates” or “recording media”), such as pieces or sheets of paper or other planar media, glass, fabric, metal, or other objects. Printers typically operate using subtractive color: a substantially reflective recording medium is overcoated image-wise with cyan (C), magenta (M), yellow (Y), black (K), and other colorants. Various schemes can be used to process images to be printed. For example, the electrophotographic (EP) printing process optically exposes a photoreceptor to form a “latent image,” which is a pattern of charge, on the photoreceptor. The latent image is used to form a pattern of toner that is transferred to a recording medium (also called a “receiver”) to form a print. However, the speed of electrophotographic printing is limited by the time required to produce the latent image. This time is determined by the properties of the photoreceptor and optical exposure source. In a conventional EP printer, to form a latent image more rapidly without reducing image density, higher irradiances are used for shorter exposure times to provide the same exposure in less time. However, this increases the drive power required from the exposure system. Image quality can also suffer since the photoreceptor can experience reciprocity failure at higher irradiance values, e.g., as shown in FIG. 21 of U.S. Publication No. 2008/0088316, which is incorporated herein by reference. There is a need, therefore, for a higher-speed way of forming a latent image.

Furthermore, toner-based printers have consumables other than toner that add to the cost of producing prints. These consumables include operator-replaceable components such as photoreceptors, transfer members, fuser rollers, and cleaning brushes and blades. There is a need, therefore, for a way to reduce the cost of producing prints.

Various two-stage printing system have been described. U.S. Pat. No. 4,312,268 to King et al. teaches the use of a liquid applied to a continuous web. After the liquid is applied to the web excess quantities of a fusible powder are applied to the web. Some of the powder adheres to the liquid, and the powder that does not adhere is removed from the web prior to heating the web to dry the liquid and fuse the powder material. The powder material provides the desired color or esthetic qualities or protective qualities. In this process, substantial quantities of toner are used and removed, effectively rendering that toner as waste. Moreover, each toner deposition requires a rewetting and reheating of the web. Thus, to produce a full color print would require at least four cycles corresponding to the deposition of cyan, magenta, yellow, and black toner. As fusing toner and evaporating liquid, especially water, is energetically intensive, this process can be expensive.

U.S. Pat. No. 4,943,816 to Sparer discloses the use of a marking fluid containing no dye so that a latent image in the form of fluid drops is formed on a piece of paper. The marking fluid is relatively non-wetting to the paper. Sporer teaches the use of a 300 dpi thermal inkjet printer to produce the latent image. Surface tension is then used to adhere colored powder. Sporer teaches that only that portion of the droplet that has not penetrated or feathered into the paper is available for attracting dry ink, so this process is unsuitable for highly-absorbent papers such as newsprint. Because of the limitations taught by Sporer of using thermal drop-on-demand and the limitation of 300 dpi, this process is only suitable for low volume, low speed printing applications requiring only modest image quality.

U.S. Pat. No. 5,563,694 to Katayama teaches an apparatus that forms raised images. Katayama teaches the use of an electrophotographic printer to form an initial toner image on paper. The toner on the initial-image sheet is then charged using a corona charger, and a polyamide resin powder having a particle size between 0.2 and 0.8 mm is applied to the charged toner. Since the scheme of U.S. Pat. No. 5,563,694 requires electrophotographic printing, it cannot provide improved print speed. Moreover, U.S. Pat. No. 5,563,694 teaches that, absent the application of the initial particles, the paper is too electrically conductive to retain an applied electrostatic charge.

There is therefore a continuing need for a way of more rapidly producing a latent image to increase the throughput of a toner-based printer, and for a way of producing a print at a lower cost.

### SUMMARY OF THE INVENTION

According to an aspect of the present invention, there is provided electrographic printing apparatus for producing a toner image on paper, the apparatus comprising:

a dryer adapted to dry a selected region of the paper to a moisture content not to exceed that of the paper equilibrated to 20% RH;

a liquid-deposition unit adapted to wet selected portions of the selected region of the paper within 15 seconds after the completion of drying to provide a latent fluid image corresponding to the wetted portions of the paper, whereby a dry area is defined in the selected region outside the latent fluid image;

a charging member for charging the paper so that the paper in the dry area has a selected potential; and

a development station for depositing charged dry toner in the selected region, the toner having charge of the same sign as the selected potential, so that the toner adheres to paper in the area of the latent fluid image.

An advantage of this invention is that toner prints can be produced without requiring a photoreceptor and the associated cleaning and transfer hardware. This permits digital printing of images having the high quality, print density, and durability of an electrophotographic print without the costs associated with exposure, photoreceptor, and toner transfer systems. Since no photoreceptor is used, reciprocity failure is not a concern.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is an elevational cross-section of an electrophotographic reproduction apparatus;

FIG. 2 is a schematic of apparatus for producing a print on paper;

FIG. 3 is a flowchart of a method of producing a print on paper;

FIG. 4 is a schematic of a drop-on-demand inkjet printer system;

FIG. 5 is a perspective of a portion of a drop-on-demand inkjet printer;

FIG. 6 shows the moisture content of paper equilibrated to relative humidity; and

FIG. 7 shows the electrical resistivity of three types of equilibrated paper as a function of the relative humidity.

The attached drawings are for purposes of illustration and are not necessarily to scale.

### DETAILED DESCRIPTION OF THE INVENTION

In the following description, some embodiments herein will be described in terms that would ordinarily be implemented as software programs. Those skilled in the art will readily recognize that the equivalent of such software can also be constructed in hardware. Because image manipulation algorithms and systems are well known, the present description will be directed in particular to algorithms and systems forming part of, or cooperating more directly with, the method in accordance with the present invention. Other aspects of such algorithms and systems, and hardware or software for producing and otherwise processing the image signals involved therewith, not specifically shown or described herein, are selected from such systems, algorithms, components, and elements known in the art. Given the system as described in the following, software not specifically shown, suggested, or described herein that is useful for implementation of various embodiments is conventional and within the ordinary skill in such arts.

A computer program product can include one or more storage media, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice methods described herein.

Various embodiments described herein use printheads or printhead components typically used in inkjet printing systems. However, inkjet printheads can transport liquids that need to be finely metered and deposited with high spatial precision, even if those liquids are not colorant-containing inks. As such, as described herein, the terms “liquid” and “ink” refer to any material that can be ejected by the inkjet printhead or inkjet printhead components described herein.

The electrophotographic (EP) printing process can be embodied in devices including printers, copiers, scanners, and facsimiles, and analog or digital devices, all of which are referred to herein as “printers.” Electrostatographic printers such as electrophotographic printers that employ toner developed on an electrophotographic recording medium can be used, as can ionographic printers and copiers that do not rely upon an electrophotographic recording medium. Electrophotography and ionography are types of electrostatography (printing using electrostatic fields), which is a subset of electrography (printing using electric fields).

A digital reproduction printing system (“printer”) typically includes a digital front-end processor (DFE), a print engine (also referred to in the art as a “marking engine”) for applying toner to the recording medium, and one or more post-printing finishing system(s) (e.g. a UV coating system, a glosser system, or a laminator system). A printer can reproduce pleasing black-and-white or color onto a recording medium. A printer can also produce selected patterns of toner on a recording medium, which patterns (e.g. surface textures) do not correspond directly to a visible image. The DFE receives input electronic files (such as Postscript command files) composed of images from other input devices (e.g., a scanner, a digital camera). The DFE can include various function processors, e.g. a raster image processor (RIP), image positioning processor, image manipulation processor, color processor, or image storage processor. The DFE rasterizes input electronic files into image bitmaps for the print engine to print. In some embodiments, the DFE permits a human operator to set up parameters such as layout, font, color, media type, or post-finishing options. The print engine takes the rasterized image bitmap from the DFE and renders the bitmap into a form that can control the printing process from the exposure device to transferring the print image onto the recording medium. The finishing system applies features such as protection, glossing, or binding to the prints. The finishing system can be implemented as an integral component of a printer, or as a separate machine through which prints are fed after they are printed.

The printer can also include a color management system which captures the characteristics of the image printing process implemented in the print engine (e.g. the electrophotographic process) to provide known, consistent color reproduction characteristics. The color management system can also provide known color reproduction for different inputs (e.g. digital camera images or film images).

In an embodiment of an electrophotographic modular printing machine, e.g. the NEXPRESS 3000SE printer manufactured by Eastman Kodak Company of Rochester, N.Y., color-toner print images are made in a plurality of color imaging modules arranged in tandem, and the print images are successively electrostatically transferred to a recording medium adhered to a transport web moving through the modules. Colored toners include colorants, e.g. dyes or pigments, which absorb specific wavelengths of visible light. Commercial machines of this type typically employ intermediate transfer members in the respective modules for transferring visible images from the photoreceptor and transferring print images to the recording medium. In other electrophotographic printers, each visible image is directly transferred to a recording medium to form the corresponding print image.

Electrophotographic printers having the capability to also deposit clear toner using an additional imaging module are also known. As used herein, clear toner is considered to be a color of toner, as are C, M, Y, K, and Lk, but the term “colored toner” excludes clear toners. The provision of a clear-toner overcoat to a color print is desirable for providing protection of the print from fingerprints and reducing certain visual artifacts. Clear toner uses particles that are similar to the toner particles of the color development stations but without colored material (e.g. dye or pigment) incorporated into the toner particles. However, a clear-toner overcoat can add cost and reduce color gamut of the print; thus, it is desirable to provide for operator/user selection to determine whether or not a clear-toner overcoat will be applied to the entire print. A uniform layer of clear toner can be provided. A layer that varies inversely according to heights of the toner stacks can also be used to establish level toner stack heights. The respective toners are deposited one upon the other at respective locations on the recording medium and the height of a respective toner stack is the sum of the toner heights of each respective color. Uniform stack height provides the print with a more even or uniform gloss.

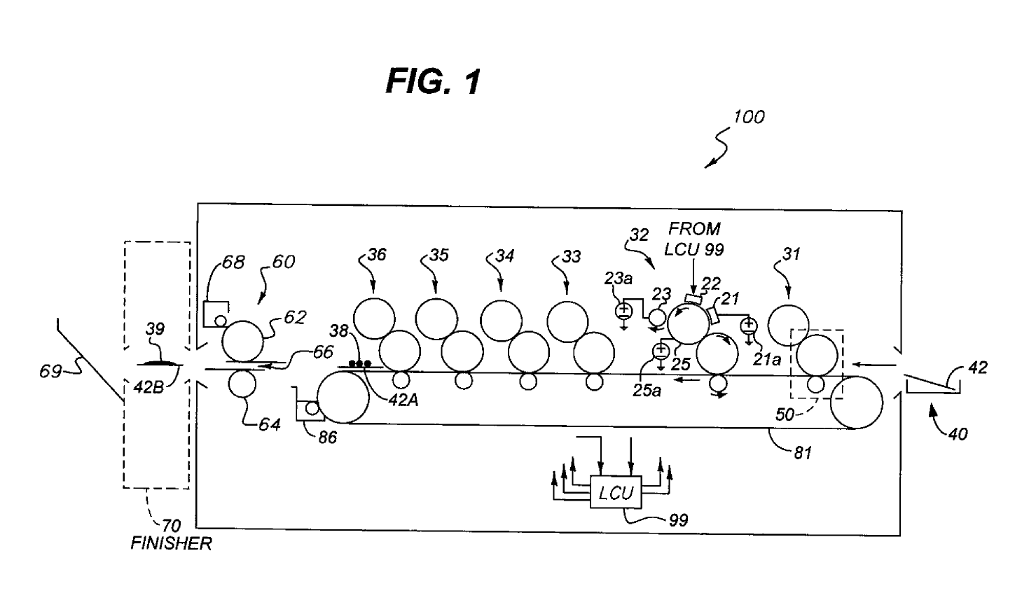

FIG. 1 is an elevational cross-section showing portions of a typical electrophotographic printer 100. Printer 100 is adapted to produce print images, such as single-color (monochrome), CMYK, or hexachrome (six-color) images, on a recording medium (multicolor images are also known as “multi-component” images). Images can include text, graphics, photos, and other types of visual content. An embodiment involves printing using an electrophotographic print engine having six sets of single-color image-producing or -printing stations or modules arranged in tandem, but more or fewer than six colors are combined to form a print image on a given recording medium. Other electrophotographic writers or printer apparatus can also be included. Various components of printer 100 are shown as rollers; other configurations are also possible, including belts.

Referring to FIG. 1, printer 100 is an electrophotographic printing apparatus having a number of tandemly-arranged electrophotographic image-forming printing modules 31, 32, 33, 34, 35, 36, also known as electrophotographic imaging subsystems. Each printing module 31, 32, 33, 34, 35, 36 produces a single-color toner image for transfer using a respective transfer subsystem 50 (for clarity, only one is labeled) to a recording medium 42 successively moved through the modules. Recording medium 42 is transported from supply unit 40, which can include active feeding subsystems as known in the art, into printer 100. In various embodiments, the visible image can be transferred directly from an imaging roller to a recording medium 42, or from an imaging roller to one or more transfer roller(s) or belt(s) in sequence in transfer subsystem 50, and thence to recording medium 42. Recording medium 42 is, for example, a selected section of a web of, or a cut sheet of, planar media such as paper or transparency film. A recording medium can be in sheet or roll form.

Each printing module 31, 32, 33, 34, 35, 36 includes various components. For clarity, these are only shown in printing module 32. Around photoreceptor 25 are arranged, ordered by the direction of rotation of photoreceptor 25, charger 21, exposure subsystem 22, and toning station 23.

In the EP process, an electrostatic latent image is formed on photoreceptor 25 by uniformly charging photoreceptor 25 and then discharging selected areas of the uniform charge to yield an electrostatic charge pattern corresponding to the desired image (a “latent image”). Charger 21 produces a uniform electrostatic charge on photoreceptor 25 or its surface. Exposure subsystem 22 selectively image-wise discharges photoreceptor 25 to produce a latent image. Exposure subsystem 22 can include a laser and raster optical scanner (ROS), one or more LEDs, or a linear LED array.

After the latent image is formed, charged toner particles are brought into the vicinity of photoreceptor 25 by toning station 23 and are attracted to the latent image to develop the latent image into a visible image. Note that the visible image may not be visible to the naked eye depending on the composition of the toner particles (e.g. clear toner). Toning station 23 can also be referred to as a development station. Toner can be applied to either the charged or discharged parts of the latent image.

After the latent image is developed into a visible image on photoreceptor 25, a suitable recording medium 42 is brought into juxtaposition with the visible image. In transfer subsystem 50, a suitable electric field is applied to transfer the toner particles of the visible image to recording medium 42 to form the desired print image 38 on the recording medium, as shown on recording medium 42A. The imaging process is typically repeated many times with reusable photoreceptors 25.

Recording medium 42A is then removed from its operative association with photoreceptor 25 and subjected to heat or pressure to permanently fix (“fuse”) print image 38 to recording medium 42A. Plural print images, e.g. of separations of different colors, are overlaid on one recording medium before fusing to form a multi-color print image 38 on recording medium 42A.

Each recording medium 42, during a single pass through the six printing modules 31, 32, 33, 34, 35, 36, can have transferred in registration thereto up to six single-color toner images to form a pentachrome image. As used herein, the term “hexachrome” implies that in a print image, combinations of various of the six colors are combined to form other colors on recording medium 42 at various locations on recording medium 42. That is, each of the six colors of toner can be combined with toner of one or more of the other colors at a particular location on recording medium 42 to form a color different than the colors of the toners combined at that location. In an embodiment, printing module 31 forms black (K) print images, printing module 32 forms yellow (Y) print images, printing module 33 forms magenta (M) print images, printing module 34 forms cyan (C) print images, printing module 35 forms light-black (Lk) images, and printing module 36 forms clear images.

In various embodiments, printing module 36 forms print image 38 using a clear toner or tinted toner. Tinted toners absorb less light than they transmit, but do contain pigments or dyes that move the hue of light passing through them towards the hue of the tint. For example, a blue-tinted toner coated on white paper will cause the white paper to appear light blue when viewed under white light, and will cause yellows printed under the blue-tinted toner to appear slightly greenish under white light.

Recording medium 42A is shown after passing through printing module 36. Print image 38 on recording medium 42A includes unfused toner particles.

Subsequent to transfer of the respective print images 38, overlaid in registration, one from each of the respective printing modules 31, 32, 33, 34, 35, 36, recording medium 42A is advanced to a fixing station 60, i.e. a fusing or fixing assembly, to fuse print image 38 to recording medium 42A. Transport web 81 transports the print-image-carrying recording media (e.g., 42A) to fixing station 60, which fixes the toner particles to the respective recording media 42A by the application of heat and pressure. The recording media 42A are serially de-tacked from transport web 81 to permit them to feed cleanly into fixing station 60. Transport web 81 is then reconditioned for reuse at cleaning station 86 by cleaning and neutralizing the charges on the opposed surfaces of the transport web 81. A mechanical cleaning station (not shown) for scraping or vacuuming toner off transport web 81 can also be used independently or with cleaning station 86. The mechanical cleaning station can be disposed along transport web 81 before or after cleaning station 86 in the direction of rotation of transport web 81.

Fixing station 60 includes a heated fixing member 62 and an opposing pressure roller 64 that form a fusing nip 66 therebetween. In an embodiment, fixing station 60 also includes a release fluid application substation 68 that applies release fluid, e.g. silicone oil, to fixing member 62. Alternatively, wax-containing toner is used without applying release fluid to fixing member 62. Other embodiments of fusers, both contact and non-contact, can be employed. For example, solvent fixing uses solvents to soften the toner particles so they bond with the recording medium 42. Photoflash fusing uses short bursts of high-frequency electromagnetic radiation (e.g. ultraviolet light) to melt the toner. Radiant fixing uses lower-frequency electromagnetic radiation (e.g. infrared light) to more slowly melt the toner. Microwave fixing uses electromagnetic radiation in the microwave range to heat the recording media (primarily), thereby causing the toner particles to melt by heat conduction, so that the toner is fixed to the recording medium 42.

The recording media (e.g., recording medium 42B) carrying the fused image (e.g., fused image 39) are transported in a series from the fixing station 60 along a path either to a remote output tray 69, or back to printing modules 31, 32, 33, 34, 35, 36 to create an image on the backside of the recording medium (e.g., recording medium 4213), i.e. to form a duplex print. Recording media (e.g., recording medium 42B) can also be transported to any suitable output accessory. For example, an auxiliary fuser or glossing assembly can provide a clear-toner overcoat. Printer 100 can also include multiple fixing stations 60 to support applications such as overprinting, as known in the art.

In various embodiments, between fixing station 60 and output tray 69, recording medium 42B passes through finisher 70. Finisher 70 performs various media-handling operations, such as folding, stapling, saddle-stitching, collating, and binding.

Printer 100 includes main printer apparatus logic and control unit (LCU) 99, which receives input signals from the various sensors associated with printer 100 and sends control signals to the components of printer 100. LCU 99 can include a microprocessor incorporating suitable look-up tables and control software executable by the LCU 99. It can also include a field-programmable gate array (FPGA), programmable logic device (PLD), microcontroller, or other digital control system. LCU 99 can include memory for storing control software and data. Sensors associated with the fusing assembly provide appropriate signals to the LCU 99. In response to the sensors, the LCU 99 issues command and control signals that adjust the heat or pressure within fusing nip 66 and other operating parameters of fixing station 60 for recording media. This permits printer 100 to print on recording media of various thicknesses and surface finishes, such as glossy or matte.

Image data for writing by printer 100 can be processed by a raster image processor (RIP; not shown), which can include a color separation screen generator or generators. The output of the RIP can be stored in frame or line buffers for transmission of the color separation print data to each of respective LED writers, e.g. for black (K), yellow (Y), magenta (M), cyan (C), and red (R), respectively. The RIP or color separation screen generator can be a part of printer 100 or remote therefrom. Image data processed by the RIP can be obtained from a color document scanner or a digital camera or produced by a computer or from a memory or network which typically includes image data representing a continuous image that needs to be reprocessed into halftone image data in order to be adequately represented by the printer. The RIP can perform image processing processes, e.g. color correction, in order to obtain the desired color print. Color image data is separated into the respective colors and converted by the RIP to halftone dot image data in the respective color using matrices, which comprise desired screen angles (measured counterclockwise from rightward, the +X direction) and screen rulings. The RIP can be a suitably-programmed computer or logic device and is adapted to employ stored or computed matrices and templates for processing separated color image data into rendered image data in the form of halftone information suitable for printing. These matrices can include a screen pattern memory (SPM).

Various parameters of the components of a printing module (e.g., printing module 31) can be selected to control the operation of printer 100. In an embodiment, charger 21 is a corona charger including a grid between the corona wires (not shown) and photoreceptor 25. Voltage source 21a applies a voltage to the grid to control charging of photoreceptor 25. In an embodiment, a voltage bias is applied to toning station 23 by voltage source 23a to control the electric field, and thus the rate of toner transfer, from toning station 23 to photoreceptor 25. In an embodiment, a voltage is applied to a conductive base layer of photoreceptor 25 by voltage source 25a before development, that is, before toner is applied to photoreceptor 25 by toning station 23. The applied voltage can be zero; the base layer can be grounded. This also provides control over the rate of toner deposition during development. In an embodiment, the exposure applied by exposure subsystem 22 to photoreceptor 25 is controlled by LCU 99 to produce a latent image corresponding to the desired print image. All of these parameters can be changed, as described below.

Further details regarding printer 100 are provided in U.S. Pat. No. 6,608,641, issued on Aug. 19, 2003, to Peter S. Alexandrovich et al., and in U.S. Publication No. 2006/0133870, published on Jun. 22, 2006, by Yee S. Ng et al., the disclosures of which are incorporated herein by reference.

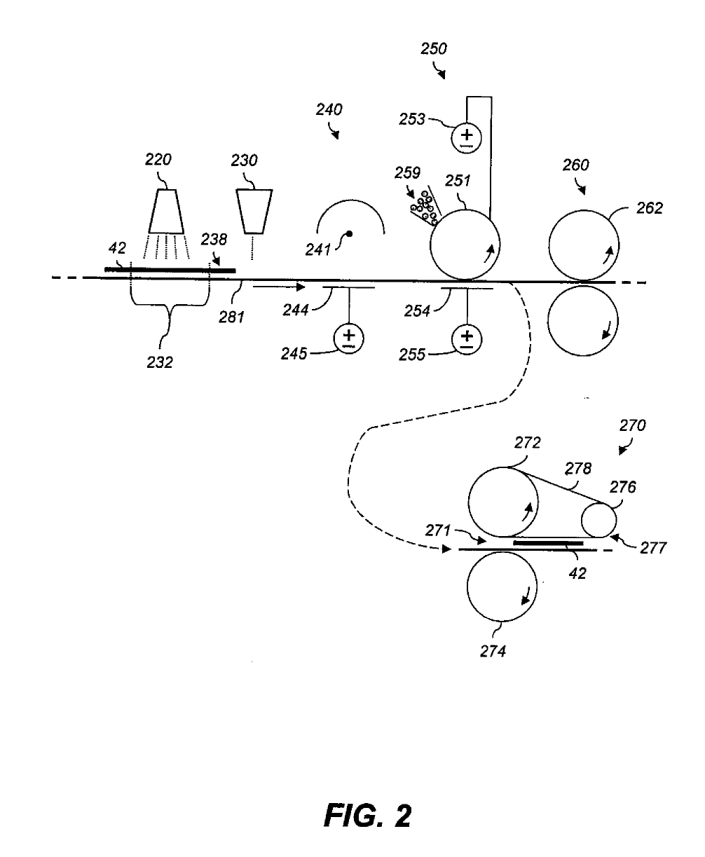

FIG. 2 is a schematic of apparatus for producing a print on paper recording medium 42. Unlike the electrophotographic printer shown in FIG. 1, this apparatus does not use photoreceptor 25 (FIG. 1) or other photosensitive imaging member to control where toner is deposited on recording medium 42.

A transport (not shown) moves the paper (recording medium 42) along a paper path (not shown). In the embodiment shown, the transport includes transport belt 281. The transport can also include a drum, stage, or other device for moving the paper (recording medium 42). Recording medium 42 can be a sheet or web. Throughout the discussion of FIG. 2 and related material, recording medium 42 is paper, and the paper path is the path along which recording medium 42 is moved through the printer.

Dryer 220, liquid-deposition unit 230, charging member 240, development station 250, and fixer 260 (or 270, as discussed below) are arranged in that order along the paper path.

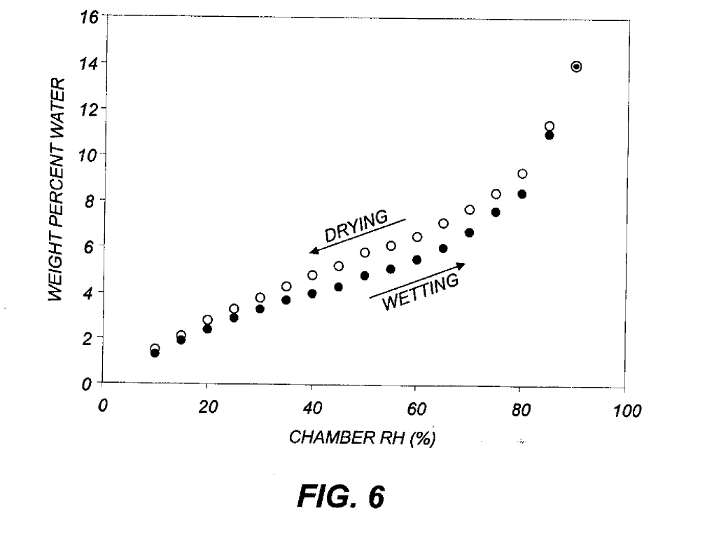

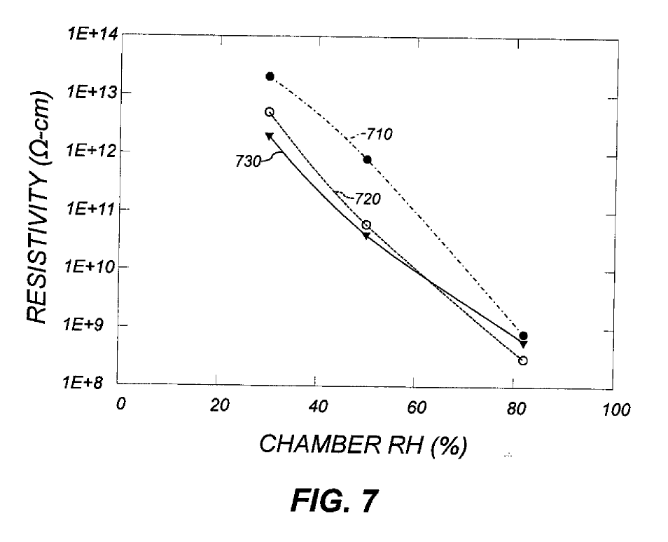

Dryer 220 dries a selected region 232 of recording medium 42 (i.e., the paper) on the transport to a moisture content not to exceed that of the paper equilibrated to 20% RH. This is as described below with reference to FIGS. 6-7. Dryer 220 can include a source of infrared or ultraviolet radiation (shown), a hot-air source, or a dehumidifier. Dryer 220 can include a heated roller (not shown). Dryer 220 can dry the paper by irradiation, heating, desiccation, or other ways.

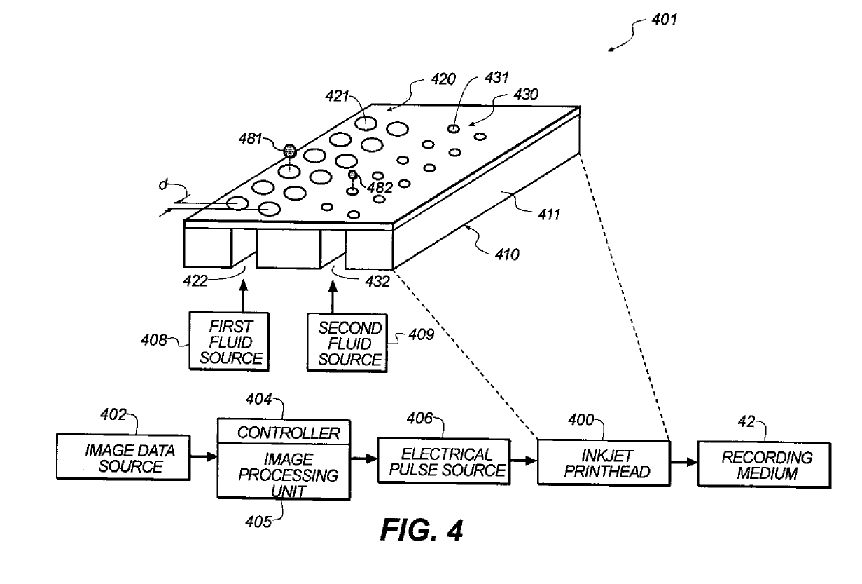

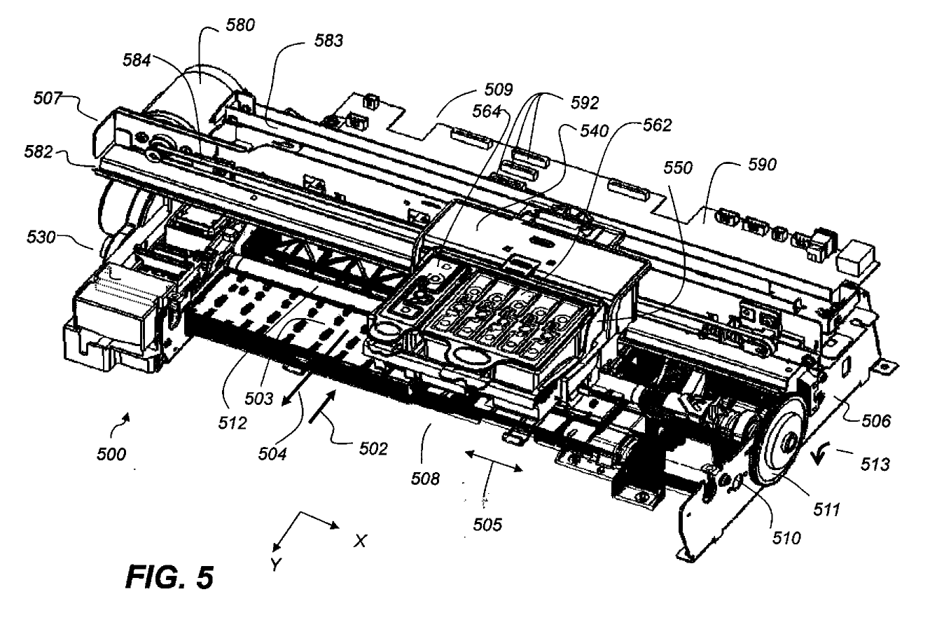

Liquid-deposition unit 230 deposits hydrophilic (oliophobic) liquid in a selected fluid pattern on all or part of region 232 of recording member 42 within 15 seconds of the completion of drying. In the embodiments shown, the speed of transport of recording medium 42 along transport belt 281 is at least fast enough to carry the leading edge of recording medium 42 from dryer 220 to liquid-deposition unit 230 in at most ten seconds. In various embodiments, the hydrophilic liquid is hydrophilic ink. In various embodiments, liquid-deposition unit 230 is an inkjet unit, e.g., one or more inkjet printheads, optionally mounted on a carriage. Inkjet deposition can be performed by drop-on-demand or continuous printheads. Inkjet deposition is discussed below with reference to FIGS. 4-5.

Charging member 240 including two electrodes 241, 244 of any shape, each connected to a power supply or a fixed potential (e.g., ground), arranged on opposite sides of the paper path. In the embodiments shown, electrode 241 is a corona wire partially surrounded by a shield, and electrode 244 is a flat plate. The electrodes selectively charge recording medium 42 in region 232 while region 232 is between them. A charge pattern of charged and discharged areas is thus formed on the paper and the charged areas have a potential of at least 100 V. That is, charging member 240 charges the dry areas, but the liquid in the wet areas discharges any local accumulations of charge, inhibiting charging. As a result, the charge pattern corresponds to the fluid pattern; the discharged areas are approximately the areas where liquid was deposited by liquid-deposition unit 230. Source 245 can provide voltage or current to electrode 244; a corresponding source (not shown) can provide voltage or current to electrode 241. In various embodiments, charging is performed by a biased roller (not shown) spaced a small distance apart from the paper.

In various embodiments, electrode 244 is a grounded (or fixed-biased) backing plate behind recording member 42 at charging member 240. In various embodiments, recording member 42 is in physical contact at one or more point(s) with electrode 244 so charge can be conducted from recording member 42 to ground (or source 245) through electrode 244. This provides more rapid and controlled charging than if the charge has to arc across an air gap between the paper and electrode 244. Charge transport without arcing also reduces the maximum voltages experienced during charging and reduces arc-induced damage to the paper. However, air-gap charging can also be used.

Development station 250 applies toner to recording medium 42. Biasable toning member 251 and separately-biasable area electrode 254 are arranged on opposite sides of region 232 of recording medium 42 when region 232 is in operational position with respect to development station 250. The biases of toning member 251 and area electrode 254 are chosen so that the electric field between toning member 251 and area electrode 254 is strong enough to deposit toner onto any point of the selected region. In various embodiments, recording medium 42 is in contact with area electrode 254.

Voltage source 253 applies a bias to toning member 251. The bias is less than the potential of the charged areas of recording medium 42 and greater than the potential of the uncharged areas of recording medium 42. Biases and potentials can be measured with respect to the area electrode. The area electrode can be driven to a specific potential by voltage source 255, or can be grounded.

Supply 259 includes charged dry toner particles. Supply 259 includes various components adapted to provide toner to the printer and charge the toner. In various embodiments, supply 259 includes a toner bottle (not shown), a gate for selectively dispensing metered amounts of toner from the bottle into a reservoir, and an auger in the reservoir for mixing the toner to tribocharge it. The charge of the toner has the same sign as the charge in the charged areas on recording medium 42.

As a result, when selected region 232 of recording medium 42 is brought into operative arrangement with development station 250, charged toner is deposited on recording medium 42 in a toner pattern corresponding to, although not necessarily identical to, the selected fluid pattern in selected region 232. The toner deposition is effected by electrical forces arising from the charge on the toner particles and the electric field between toning member 251, area electrode 254, and the charge pattern on recording medium 42. For example, with positively charged toner, the electric field can be oriented from toning member 251 to area electrode 254 to exert a force on the charged toner particles on toning member 251 to move them towards recording medium 42.

In various printers such as those shown in FIG. 1, silica surface treatments are added to the toner to assist transfer by transfer subsystem 50. These treatments are submicrometer particulate addenda on the surface of the toner particles. In embodiments shown in FIG. 2, no transfer step is performed, since the toner is developed directly onto recording medium 42. Therefore, in various embodiments, toners not containing silica surface treatments are used. Silica can make toner less cohesive and lead to increased satellite formation. In embodiments not using silica, smaller toner particles (e.g., 4-12 um) can be used, thereby providing improved resolution; the lack of a transfer step provides this advantage without increasing satellite formation.

Fixer 260 is adapted to permanently fix the deposited toner to recording medium 42. In an example, fixing station 60 (FIG. 1) is used as fixer 260. In various embodiments, fixer 260 includes heated fixing member 262.

In various embodiments, the transport includes transport belt 281 onto which recording member 42 is held (e.g., electrostatically). The toner is deposited on a toner side 238 of recording member 42 away from transport belt 281. In these embodiments, fixer 270 is used instead of fixer 260 to provide a desired surface finish, e.g., a glossy finish. Fixers 260 and 270 can also be used together in either order.

First and second rotatable members 272, 274, respectively, are arranged to form nip 271 through which transport belt 281 and recording member 42 pass. First rotatable member 272 is disposed on toner side 238 of recording member 42. At least one of the rotatable members 272, 274 is heated, e.g., rotatable member 272.

Tensioning member 276 is positioned downstream of first and second rotatable members 272, 274 in the direction of travel of recording medium 42. Rotatable finishing belt 278 is entrained around first rotatable member 272 and tensioning member 276. As a result, separation point 277 is defined at which recording medium 42 separates from finishing belt 278. Finishing belt 278 has a desired surface finish or texture, e.g., a smooth surface for a glossy print, or a textured surface for a ferrotyped print. The length and the speed of rotation of finishing belt 278 are selected so that toner on recording medium 42 is heated above its glass transition temperature (Tg) by the heated one of the rotatable members 272, 274 and the toner on recording medium 42 cools to below Tg before reaching separation point 277.

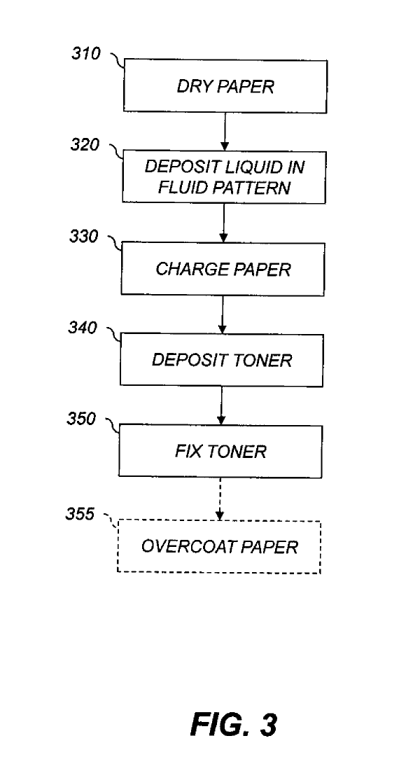

FIG. 3 shows a method of producing a print on paper. Processing begins with step 310. In step 310, a selected region of the sheet or web of paper is dried to a moisture content not to exceed that of the paper equilibrated to 20% RH. This increases the electrical resistivity of the paper so that it will retain an electric charge for a sufficient time as to permit toner to be deposited onto the paper, as discussed below with reference to FIGS. 6-7.

In various embodiments, the paper is dried by letting it rest in dry air until it equilibrates, e.g., by holding the paper in an environmental chamber or by passing the paper through a container holding a desiccant such as calcium chloride. In other embodiments, the paper is dried by heating. Noncontact heating devices spaced apart from the paper, such as heated membranes, heated wires, or radiant sources of microwave, IR, or RF energy, can be used. The paper can also be heated through contact with a heated member such as a hot plate or heated roller. The paper is preferably heated to at least 110° C. and is preferably not heated to a temperature that will cause degradation of the paper, e.g., blistering, yellowing, embrittlement, or burning. Step 310 is followed by step 320.

In step 320, hydrophilic liquid is deposited in a selected fluid pattern on all or part of the selected region of the paper within 15 seconds after the completion of drying. A device such as an inkjet printer, as discussed above, can be used to deposit the liquid. The fluid pattern can be image-wise. The hydrophilic liquid can include water as a solvent, or can include other hydrophilic liquids such as alcohols with 4 or fewer carbons such as methanol, isopropanol, ethanol, propanol, butanol, or glycol. The “front” of the paper is defined as that face of the paper on which the liquid is deposited; the “back” of the paper is the other face. The roles of “front” and “back” are reversed in the second pass of a duplex print through a printer.

In various embodiments, the hydrophilic liquid is an ink or other liquid containing colorant. The colorant in the liquid can be a pigment in a stable colloidal suspension. This requires that the pigment be sufficiently electrically charged to remain stable. More specifically, the pigments are charged at a first polarity, thereby producing an electrical double layer of counter charge in the solvent. A suitable parameter to characterize the charge of the pigment is the zeta potential, as is known in the literature and measurable using commercially available devices. In other embodiments, the colorant is a dye dissolved or suspended in the liquid.

In various embodiments, the hydrophilic liquid includes colorant and the dry toner does not include colorant. This embodiment can be useful for producing inkjet prints with effects, such as a glossy surface or raised-letter (tactile) printing. The inkjet image can be produced using colored inks, and clear toner particles can be applied to provide the finish or texture.

In various embodiments, the dry toner can include toner particles having diameters between 4 μm and 25 μm.

In various embodiments, the surface of the paper to which the fluid pattern is applied is a porous surface. In an example, the paper does not include a clay coating on its surface. Such papers are commonly sold as bond papers (or calendared papers, which have a smoother uncoated surface).

In various embodiments, the paper has a semiporous surface. Papers with such a surface include as graphic arts papers with a clay coating, e.g., Warren Offset Enamel, Potlatch Vintage Gloss, Potlatch Vintage Velvet, or Kromekote.

Nonporous papers, e.g., TESLIN, a microvoided polymeric material, or polyethylene coated paper stock (used in photofinishing applications and designed to be submerged in aqueous solutions during a silver halide development process) are not suitable for use with this method. Papers and other types of substrates into the surface of which the hydrophilic liquid can penetrate, and in which resistivity is correlated with moisture content, are suitable for use.

Step 320 is followed by step 330.

In step 330, the paper is charged so that a charge pattern of charged and discharged areas is formed on the paper, wherein the discharged areas correspond to the selected fluid pattern. In various embodiments, the paper is positioned between a biasable backing member and a charging member. The biasable backing member can be a plate and is preferably electrically grounded. The back side of the paper is preferably in contact with the backing member. In various embodiments, the recording medium is transported on an electrically-conductive belt and the belt is the backing member.

In various embodiments, the paper is electrically charged to a potential between 100V and 1000V with a charge of a first polarity. The fluid pattern, the area that received the hydrophilic liquid on the front side, is more electrically conductive than the non-jetted area. As a result, the fluid pattern does not hold the imposed electrical charge. The charge is held in the dry area of the paper outside the fluid pattern.

Step 330 is followed by step 340.

In step 340, charged dry toner having charge of the same sign as the charge in the charged areas on the paper is deposited onto the paper in a toner pattern corresponding to, although not necessarily identical to, the selected fluid pattern in the selected region. The toner pattern can deviate from the fluid pattern because of the stochastic nature of the dry-toner deposition process.

To deposit the toner, the paper is brought into operational proximity to a biased development station containing dry toner. The toner has a charge of the first polarity, as does the charge in the dry areas of the paper. The bias on the development station has the same first polarity. This is a discharged-area development (DAD) process. After deposition, the dry toner is held to the surface of the paper by forces including van der Waal's forces.

In various embodiments, the magnitude of the bias on the development station is less than that on the dry areas of the paper, so that dry toner in proximity with the paper is driven into the discharged areas corresponding to the fluid pattern. In various embodiments, the bias applied to the development station is less than the bias applied to the dry portions of the paper but greater than the bias on the wet portions of the paper. In various embodiments, the development station is a magnetic development station, as described above, or an aerosol or powder-cloud development station.

Step 340 is followed by step 350.

In step 350, the toner is permanently fixed (e.g., fused) to the paper. This can be accomplished by subjecting the image-bearing recording medium to heat and pressure to raise the temperature of the toner above its glass transition temperature T_{g}, i.e., to raise the toner's temperature so the toner is viscous rather than glassy. The viscous toner particles adhere to the recording medium and cohere to other toner particles to form a coherent toner mass. The pressure forces the toner particles to flow together and encourages adhesion to the paper. In various embodiments, prints with a high gloss are produced by casting the printed paper against a smooth surface, such as a nickel or polyimide belt, under heat and pressure. This can be done after fixing or instead of fixing. The toner on the print is permitted to cool below T_{g} before it is separated from the belt.

In various embodiments, tactile prints are produced. Tactile prints are prints having raised features than can be perceived by the sense of touch. Examples include Braille prints, raised-letter prints, and raised-texture prints. In some of these embodiments, the toner deposited on the paper has a median volume-weighted diameter of at least 20 μm. In some of these embodiments, the toner is clear, or uncolored, or does not contain a colorant. The toner therefore provides texture without significantly affecting the appearance of any content present underneath the toner. In some of these embodiments, clear toner is used together with a hydrophilic liquid containing colorants, e.g., dyes or pigments. This provides prints having color images or other patterns printed with the hydrophilic liquid, and tactile features formed from the clear toner over those patterns.

In various embodiments, the toner deposited on the paper includes thermoplastic polymer binders. Some of these binders will cross-link when activated (e.g., by heat or UV), and some of these binders will not. The latter will soften when exposed to heat during fixing or glossing, and then return to a glassy state when they cool. Toners containing binders of the former type are referred to herein as “thermosettable toners.” Toners containing binders of the latter type are referred to herein as “fusible toners.” The binders of both thermosettable toners and fusible toners are in the thermoplastic state when the toner is deposited on the recording medium. After thermosettable toners are fixed, their binders are in the thermoset state.

In fixing step 350, heat or pressure is applied to fusible toners. In fixing step 350, thermosettable toners are activated so that their binders begin to cross-link instead of softening. Thermosettable toners can also be heated either as part of or in addition to activating their binders, and either before or after activation.

In various embodiments, thermosettable toners are used. The hydrophilic liquid has no significant chemical interactions with the binders, and the binders cross-link when activated in fixing step 350.

In various embodiments, thermosettable toners are used. The hydrophilic liquid reacts chemically with the thermosettable toners to cause the toners to cross-link. This reaction can take place on contact, during deposition step 340, or take place upon activation in fixing step 350.

In various embodiments, “thermoset toners” (as opposed to thermosettable toners) are deposited in step 340. Thermoset toners are toners whose binders are already in the thermoset state (i.e., already cross-linked) when they are deposited on the paper. In these embodiments, fixing step 350 is followed by overcoating step 355. In overcoating step 355, an overcoating material such as a varnish is applied to the paper bearing the thermoset toner. The overcoating material adheres the thermoset toner to the recording medium. In various embodiments, the hydrophilic liquid is an adhesive. The thermoset toners are adhered to the paper by the hydrophilic liquid.

FIG. 4 is a schematic of a drop-on-demand inkjet printer system 401. Further details are provided in U.S. Pat. No. 7,350,902, the disclosure of which is incorporated herein by reference. Inkjet printer system 401 includes an image data source 402, which provides data signals that are interpreted by a controller 404 as being commands to eject drops. Controller 404 includes an image processing unit 405 for rendering images for printing, and outputs signals to an electrical pulse source 406. Electrical pulse source 406 produces electrical energy pulses that are inputted to an inkjet printhead 400 that includes at least one inkjet printhead die 410.

In the example shown in FIG. 4, there are two nozzle arrays. Nozzles 421 in the first nozzle array 420 have a larger opening area than nozzles 431 in the second nozzle array 430. In this example, each of the two nozzle arrays has two staggered rows of nozzles, each row having a nozzle density of 600 per inch. The effective nozzle density then in each array is 1200 per inch (i.e. spacing d= 1/1200 inch in FIG. 4). If pixels on the recording medium 42 were sequentially numbered along the paper advance direction, the nozzles from one row of an array would print the odd numbered pixels, while the nozzles from the other row of the array would print the even numbered pixels.

In fluid communication with each nozzle array is a corresponding ink delivery pathway. Ink delivery pathway 422 is in fluid communication with the first nozzle array 420, and ink delivery pathway 432 is in fluid communication with the second nozzle array 430. Portions of ink delivery pathways 422 and 432 are shown in FIG. 4 as openings through printhead die substrate 411. One or more inkjet printhead die 410 are included in an inkjet printhead, but for greater clarity only one inkjet printhead die 410 is shown in FIG. 4. The printhead die are arranged on a support member. In FIG. 4, first fluid source 408 supplies ink to first nozzle array 420 via ink delivery pathway 422, and second fluid source 409 supplies ink to second nozzle array 430 via ink delivery pathway 432. Although distinct fluid sources 408 and 409 are shown, in some applications there is a single fluid source supplying ink to both the first nozzle array 420 and the second nozzle array 430 via ink delivery pathways 422 and 432, respectively. Also, in some embodiments, fewer than two or more than two nozzle arrays can be included on printhead die 410. In some embodiments, all nozzles on inkjet printhead die 410 can be the same size, rather than having multiple sized nozzles on inkjet printhead die 410.

Not shown in FIG. 4 are the drop-forming mechanisms associated with the nozzles. Drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by heating a bi-layer element) and thereby cause ejection. In any case, electrical pulses from electrical pulse source 406 are sent to the various drop ejectors according to the desired deposition pattern. In the example of FIG. 4, droplets 481 ejected from the first nozzle array 420 are larger than droplets 482 ejected from the second nozzle array 430, due to the larger nozzle opening area. Typically other aspects of the drop forming mechanisms (not shown) associated respectively with nozzle arrays 420 and 430 are also sized differently in order to customize the drop ejection process for the different sized drops. During operation, droplets of ink are deposited on a recording medium 42.

An assembled drop-on-demand inkjet printhead (not shown) includes a plurality of printhead dice, each similar to printhead die 410, and electrical and fluidic connections to those dice. Each die includes one or more nozzle arrays, each connected to a respective ink source. In an example, three dice are used, each with two nozzle arrays, and the six nozzle arrays on a printhead are respectively connected to cyan, magenta, yellow, text black, and photo black inks, and a colorless protective printing fluid. Each of the six nozzle arrays is disposed along a nozzle array direction and can be ≦1 inch long. Typical lengths of recording media are 6 inches for photographic prints (4 inches by 6 inches) or 11 inches for paper (8.5 by 11 inches). Thus, in order to print a full image, a number of swaths are successively printed while moving the printhead across recording medium 42. Following the printing of a swath, the recording medium 42 is advanced along a media advance direction that is substantially parallel to the nozzle array direction.

FIG. 5 is a perspective of a portion of a drop-on-demand inkjet printer. Some of the parts of the printer have been hidden in the view shown in FIG. 5 so that other parts can be more clearly seen. Printer chassis 500 has a print region 503 across which carriage 540 is moved back and forth in carriage scan direction 505 along the X axis, between the right side 506 and left side 507 of printer chassis 500, while drops are ejected from printhead die 410 (not shown in FIG. 5) on printhead assembly 550 that is mounted on carriage 540. Carriage motor 580 moves belt 584 to move carriage 540 along carriage guide rail 582. An encoder sensor (not shown) is mounted on carriage 540 and indicates carriage location relative to an encoder fence 583.

Printhead assembly 550 is mounted in carriage 540, and multi-chamber ink tank 562 and single-chamber ink tank 564 are installed in printhead assembly 550. A printhead together with installed ink tanks is sometimes called a printhead assembly. The mounting orientation of printhead assembly 550 as shown here is such that the printhead die 410 are located at the bottom side of printhead assembly 550, the droplets of ink being ejected downward onto the recording medium (not shown) in print region 503 in the view of FIG. 5. Multi-chamber ink tank 562, in this example, contains five ink sources: cyan, magenta, yellow, photo black (Lk), and colorless protective fluid; while single-chamber ink tank 564 contains the ink source for text black. In other embodiments, rather than having a multi-chamber ink tank to hold several ink sources, all ink sources are held in individual single chamber ink tanks. Paper or other recording medium (sometimes generically referred to as paper or media herein) is loaded along paper load entry direction 502 toward front 508 of printer chassis 500.

A variety of rollers can be used to advance the recording medium through the printer. In an example, a pick-up roller moves the top piece or sheet of a stack of paper or other recording medium in a paper load entry direction. A turn roller acts to move the paper around a C-shaped path (in cooperation with a curved rear wall surface) so that the paper is oriented to advance along media advance direction 504 from rear 509 of printer chassis 500 (in the +Y direction of the Y axis). The paper is then moved by the feed roller 512 and one or more idler roller(s) (not shown) to advance along media advance direction 504 across print region 503, and from there to a discharge roller and star wheel(s) (not shown) so that printed paper exits along the media advance direction 504. Feed roller 512 includes a feed roller shaft along its axis, and feed roller gear 511 is mounted on the feed roller shaft. Feed roller 512 can include a separate roller mounted on the feed roller shaft, or can include a thin high friction coating on the feed roller shaft. A rotary encoder (not shown) can be coaxially mounted on the feed roller shaft in order to monitor the angular rotation of the feed roller.

The motor that powers the paper advance rollers is not shown in FIG. 5. Hole 510 at right side 506 of the printer chassis 500 is where the motor gear (not shown) protrudes through in order to engage feed roller gear 511 and the gear for the discharge roller (not shown). For normal paper pick-up and feeding, it is desired that all rollers rotate in forward rotation direction 513. Maintenance station 530 is located toward left side 507 of printer chassis 500.

Toward the rear 509 of the printer chassis 500, in this example, is located the electronics board 590, which includes cable connectors 592 for communicating via cables (not shown) to the printhead carriage 540 and from there to the printhead assembly 550. Also on the electronics board are mounted motor controllers for the carriage motor 580 and for the paper advance motor, a processor or other control electronics (shown schematically as controller 404 and image processing unit 405 in FIG. 4) for controlling the printing process, and an optional connector for a cable to a host computer.

In other embodiments, continuous inkjet printing is used. A pressurized ink source is used to eject a filament of fluid through a nozzle bore from which ink drops are continually formed using a drop forming device. The ink drops are directed to a desired location using electrostatic deflection, heat deflection, gas-flow deflection, or other deflection techniques. “Deflection” refers to a change in the direction of motion of a given drop. For simplicity, drops will be described herein as either undeflected or deflected. However, “undeflected” drops can be deflected by a certain amount, and “deflected” drops deflected by more than the certain amount. Alternatively, “deflected” and “undeflected” drops can be deflected in opposite directions.

In various embodiments, to print in an area of a recording medium or recording medium, undeflected ink drops are permitted to strike the recording medium. To provide unprinted areas of the recording medium, drops which would land in that area if undeflected are instead deflected into an ink capturing mechanism such as a catcher, interceptor, or gutter. These captured drops can be discarded or returned to the ink source for re-use. In other embodiments, deflected ink drops strike the recording member to print, and undeflected ink drops are collected in the ink capturing mechanism to provide non-printing areas.

Deflection can be accomplished by differentially heating the stream to cause drops of two different sizes (“large” and “small”) to form. Differently-sized drops are then deflected different amounts because of the relatively higher inertia of the large drops compared to the small drops. An asymmetric heater or a ring heater (either segmented or not segmented) can be used and can be located in a nozzle plate on one or both sides of an ink nozzle. Examples of this type of drop formation are described in, for example, U.S. Pat. No. 6,457,807, issued to Hawkins et al., on Oct. 1, 2002; U.S. Pat. No. 6,491,362, issued to Jeanmaire, on Dec. 10, 2002; U.S. Pat. No. 6,505,921, issued to Chwalek et al., on Jan. 14, 2003; U.S. Pat. No. 6,554,410, issued to Jeanmaire et al., on Apr. 29, 2003; U.S. Pat. No. 6,575,566, issued to Jeanmaire et al., on Jun. 10, 2003; U.S. Pat. No. 6,588,888, issued to Jeanmaire et al., on Jul. 8, 2003; U.S. Pat. No. 6,793,328, issued to Jeanmaire, on Sep. 21, 2004; U.S. Pat. No. 6,827,429, issued to Jeanmaire et al., on Dec. 7, 2004; and U.S. Pat. No. 6,851,796, issued to Jeanmaire et al., on Feb. 8, 2005, the disclosures of all of which are incorporated herein by reference. Various embodiments can use gas flow deflection as described in U.S. Pat. No. 6,588,888 or U.S. Pat. No. 4,068,241, or electrostatic deflection as described in U.S. Pat. No. 4,636,808, the disclosures of all of which are incorporated herein by reference.

FIG. 6 shows the moisture content of a selected representative paper, measured in weight percent of water, as a function of atmospheric relative humidity (RH), measured in percent. To take these measurements, the paper was placed in a chamber containing air at low RH. The moisture content of the chamber was increased in a series of steps. At each step, the paper was left in the chamber for enough time to permit it to equilibrate with the atmosphere in the chamber. The moisture content of the paper was measured. The resulting data are shown in the solid circles (“wetting”). After reaching a high RH, the chamber RH was reduced stepwise. As before, at each step the paper was permitted to equilibrate, then was measured. The resulting data are shown in the open circles (“drying”). As shown, there is some hysteresis in the moisture content.

FIG. 7 shows the electrical resistivity (Ω-cm) of three types of paper as a function of atmospheric relative humidity, as defined above with reference to FIG. 6. The abscissa is chamber RH and the ordinate is resistivity, plotted on a log₁₀ scale from 100 MΩ to 100 TΩ. Curve 710 is for a 60-lb. (60#) KROMEKOTE paper, curve 720 is for a 70# POTLATCH VINTAGE paper, and curve 730 is for a 20# UNISOURCE bond paper. As RH increases from under 40% to over 80%, resistivity drops by three to four orders of magnitude.

As a result of this resistivity, low-equilibrated-RH (e.g., dry) paper can hold an electric charge. If electric charge is deposited onto an electrically grounded material, an electrically leaky capacitor is formed. The electric charge will exponentially decay with a time constant r given by the product of the resistivity of the material and the dielectric constant of the material. In a period equal to one time constant, the charge and resulting potential on the material will decay to 1/e or approximately 1/2.7 (≈37%) of its initial value (e=ln(1)). In a period 5τ long, 99.3% of the charge and potential will dissipate. The dielectric constant of paper is approximately 3 times the permittivity of free space or ˜3×(8.85×10⁻¹²) F/m. As shown in FIG. 7, the resistivity of paper whose moisture content is equilibrated to 50% RH is approximately 1×10¹¹ Ω-cm or 1×10⁹ Ω-m. Thus, τ≈0.027 s, so in 0.13 s 99.7% of the charge deposited on paper whose moisture content is equilibrated to 50% RH will be dissipated. However, if the paper is dried to a moisture content equilibrated to 20% RH, the resistivity increases to between 10¹² and 10¹⁴ Ω-cm. For a resistivity of 10¹³ Ω-cm=10¹¹Ω-m, τ≈267 s, so the charge and resulting voltage on the recording medium would only decay by 3.7% in ten seconds. In various embodiments described below, paper is dried to an equilibrated RH providing sufficient resistivity that the amount of discharge in ten seconds is acceptable.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred embodiments thereof, but it will be understood that variations, combinations, and modifications can be effected by a person of ordinary skill in the art within the spirit and scope of the invention.

### PARTS LIST

21 charger
21a voltage source
22 exposure subsystem
23 toning station
23a voltage source
25 photoreceptor
25a voltage source
31, 32, 33, 34, 35, 36 printing module
38 print image
39 fused image
40 supply unit
42, 42A, 42B recording medium
50 transfer subsystem
60 fixing station
62 fixing member
64 pressure roller
66 fusing nip
68 release fluid application substation
69 output tray
70 finisher
81 transport web
86 cleaning station
99 logic and control unit (LCU)
100 printer
220 dryer
230 liquid-deposition unit
232 region
238 toner side
240 charging member
241, 244 electrode
245 source
250 development station
251 toning member
253 voltage source
254 area electrode
255 voltage source
259 supply
260 fixer
262 fixing member
270 fixer
271 nip
272, 274 rotatable member
276 tensioning member
277 separation point
278 finishing belt
281 transport belt
310 dry paper step
320 deposit liquid in fluid pattern step
330 charge paper step
340 deposit toner step
350 fix toner step
355 overcoat paper step
400 inkjet printhead
401 inkjet printer system
402 image data source
404 controller
405 image processing unit
406 electrical pulse source
408 first fluid source
409 second fluid source
410 inkjet printhead die
411 substrate
420 first nozzle array
421 nozzle(s)
422 ink delivery pathway (for first nozzle array)
430 second nozzle array
431 nozzle(s)
432 ink delivery pathway (for second nozzle array)
481 droplet(s) (ejected from first nozzle array)
482 droplet(s) (ejected from second nozzle array)
500 printer chassis
502 paper load entry direction
503 print region
504 media advance direction
505 carriage scan direction
506 right side of printer chassis
507 left side of printer chassis
508 front of printer chassis
509 rear of printer chassis
510 hole (for paper advance motor drive gear)
511 feed roller gear
512 feed roller
513 forward rotation direction (of feed roller)
530 maintenance station
540 carriage
550 printhead assembly
562 multi-chamber ink tank
564 single-chamber ink tank
580 carriage motor
582 carriage guide rail
583 encoder fence
584 belt
590 printer electronics board
592 cable connectors
710, 720, 730 curve
d spacing
X axis
Y axis

1. Electrographic printing apparatus for producing a toner image on paper, the apparatus comprising:
a dryer adapted to dry a selected region of the paper to a moisture content not to exceed that of the paper equilibrated to 20% RH;
a liquid-deposition unit adapted to wet selected portions of the selected region of the paper within 15 seconds after the completion of drying to provide a latent fluid image corresponding to the wetted portions of the paper, whereby a dry area is defined in the selected region outside the latent fluid image;
a charging member for charging the paper so that the paper in the dry area has a selected potential; and
a development station for depositing charged dry toner in the selected region, the toner having charge of the same sign as the selected potential, so that the toner adheres to paper in the area of the latent fluid image.

2. The apparatus according to claim 1, wherein the toner includes particles having diameters less than 200 μm.

3. The apparatus according to claim 1, wherein the toner includes particles having diameters between 4 μm and 25 μm.

4. The apparatus according to claim 1, wherein the toner does not include colorant.

5. The apparatus according to claim 1, wherein the toner includes toner particles and does not include particulate addenda having diameters <1 μm on a surface of the toner particles.

6. The apparatus according to claim 5, wherein the toner particles have diameters between 4 μm and 12 μm.

7. The apparatus according to claim 1, wherein the charging member includes two electrodes arranged on opposite sides of the paper path and adapted to selectively charge the selected region of the paper between them.

8. The apparatus according to claim 1, wherein the development station includes a biasable toning member and a biasable area electrode arranged on opposite sides of the selected region of the paper.
